(19) United States
(12) Patent Application Publication
(10) Pub. No.: US 2003/0125649 A1
(43) Pub. Date: Jul. 3, 2003

(54) Method and system apparatus using temperature and pressure for treating medical disorders

(76) Inventors: Laura Janet McIntosh, Palo Alto, CA (US); Barry Hickerson, Modesto, CA (US)

Correspondence Address: Laura McIntosh, 832 Kipling St #3, Palo Alto, CA, 94301, US

(21) Appl. No.: 10/282,845

(22) Filed: Oct. 29, 2002

Related U.S. Application Data
(60) Provisional application No. 60/335,198, filed on Oct. 31, 2001.

(51) Int. Cl. A61H 1/00

(52) U.S. Cl. 601/15; 601/148

(57) ABSTRACT

A method and apparatus is disclosed for providing therapy for acute or chronic wounds and other clinical conditions, and/or for altering flow of bodily fluids, that uses pressure and temperature to promote healing or comfort. The pressure can be negative, positive, or cyclic to promote bodily fluid flow, particularly in cases of venous insufficiency. The pressure is supplied by a chamber that encases the desired site and seals to the skin of the patient, and a pump that controls the pressure within the chamber. The temperature is supplied by a heat exchange surface in proximity to the skin within the area surrounded by the pressure chamber, and can be any temperature within the range of physiological tolerance; including temperatures both above and below normal physiological temperatures. The temperature of the heat exchange surface is controlled by an apparatus outside the chamber, and may be continuous or cyclic. The heat exchange surface may have a disposable covering that serves as a wound dressing. Generally, the heat exchange surface is applied to the skin surface at a desired temperature, the chamber is sealed over the area, and pressure is drawn. The patient may be treated over a period of time ranging from minutes to weeks or months.

### RELATED APPLICATIONS

The present application claims priority benefit under 35 USC 19(e) from U.S. Provisional Application No. 60/335,198 filed Oct. 31, 2001, entitled “METHOD AND SYSTEM APPARATUS FOR TREATING ACUTE AND CHRONIC WOUNDS, SKIN AND JOINT DISORDERS AND OTHER CLINICAL CONDITIONS, AND FOR ALTERING BODY FLUID CIRCULATION” which is incorporated herein by reference.

### FIELD OF THE INVENTION

The field of this invention is temperature and pressure therapy for medical purposes.

### BACKGROUND OF THE INVENTION

The present invention relates to healing diverse medical conditions and to altering bodily fluid circulation, especially in cases where rates of healing or circulation are below average. Such circumstances include tissue ulcers and wounds related to vascular insufficiency or peripheral vascular disease, and prevention of venous stasis, thrombosis, or lymphedema. Improved circulation can also increase drug delivery to a local area when it is delivered through the circulation. Such medical conditions can occur anywhere on the body, such as pressure point sores on bed-bound patients and foot ulcers in geriatric and diabetic patients. This disclosure includes all such medical circumstances, but the current embodiment of the apparatus will focus primarily on conditions found on patient's extremities, specifically the foot. Prophylactic treatment and symptom relief for chronic disorders that are not manifested by an overt wound may also be helped by temperature and pressure therapy that stimulates circulation of blood or lymph. This includes treatment of joints for conditions such as arthritis or gout, treatment of venous insufficiency disorders such as Reynaud's Syndrome, decreased peripheral circulation from exposure to cold, maintaining comfortable temperatures in the extremities of geriatric patients, decreasing blood pooling in the extremities of geriatric patients, and various dermatological disorders. All these disorders are relieved by increased blood flow and normothermia within the tissue.

Slow-healing wounds and fluid accumulation in tissues are serious threats to the well-being of many patients, particularly those with chronic diseases like diabetes, or to the elderly. Chronic sores are painful and provide access to the body for a variety of pathogens, predisposing the patient to sepsis, gangrene, and possibly further surgical loss of tissue because of the need for debridement and amputation. Without effective intervention at the extremities, some patients lose progressively more and more of their limb as wounds fail to heal and it becomes necessary to remove tissue. Other interventions, such as skin grafts, also fail when blood flow is not sufficient to sustain the tissue. The healing of acute wounds also benefits from increased blood flow and heightened localized temperature, as would be supplied by this technology. The cost to the patient and the family in economic and social measures when a medical condition does not heal or heals slowly can be very high.

Pressure and temperature therapies are well known to both modem and traditional medicine. Massage and ‘cupping’ therapies were recommended by old Asian and European medical texts. Hot water bottles and positive pressure inflatable wraps are current manifestations of this tradition. Prior art includes negative pressure devices that reduce surface tissue pressure to promote wound healing and tissue migration, and cyclic pressure to mimic the effects of massage and push body fluids from distal to proximal tissues. These devices require the creation of a seal around the affected area, and the generation of pressure by an outside unit.

Temperature has been used for many purposes, from using ice packs to decrease inflammation to administering hot pads to reduce muscle cramps and promote blood flow through an area. Temperature therapy is also useful for clinical and subclinical symptoms related to exposure to low environmental temperatures, especially warming the hands and feet of winter outdoor sports enthusiasts or people who work in extremely low temperatures. Physiologically normal body temperatures are linked to proper tissue, cell, and biochemical functions, including effective immune surveillance and tissue regeneration. Therefore, administering warmth to a body surface and bringing it to approximately normal core body temperature (37° C.) is generally accepted to be good patient care and may potentially speed healing of damaged tissues.

This invention combines temperature and pressure within a single treatment system to promote healing and comfort in patients with venous insufficiency within a defined body part(s).

### SUMMARY OF THE INVENTION

We propose to combine temperature and pressure therapy into one system. The system is generally describable as a heat exchange surface held in proximity to the patient and within a chamber that supplies pressure to the enclosed area. The temperature and pressure differentials are supplied by a device(s) outside the treatment area, but in communication with the heat exchange surface and the pressure chamber. The intended use of the device is to contact the surface of the patient and alter the temperature and pressure of proximal tissues so as to relieve disease conditions.

The current embodiment of the device is a water-perfused heat exchange surface resembling a therapy pad, regulated by a control unit. The heat exchange surface is temperature regulated by fluid circulating through a circuit that communicates between the heat exchanger on the therapy pad and the portable control unit, and is intended to warm surface blood and tissue of a patient. The control unit monitors and adjusts the temperature and flow rate of the fluid through the therapy pad. One version of such a control unit is described under patent Ser. No. 10/187,107, which comprises a portable unit for the pumping and heating of medical fluids. Not previously described are the following features: addition of the ability to control pressure in the vicinity of a heat exchange surface, a covering on the heat exchange surface that could serve as a tissue dressing, a chamber that can be shaped to fit any extremity or can be shaped like a dome, a ring, or any other shape to cover a tissue surface that is not an extremity, the introduction of substances into the treatment area such as gases, liquids, or solids that promote healing, and ability to use pressure to either introduce or remove substances from the treatment site.

The present invention is an improved treatment for injured tissues, and for either increasing or decreasing fluid flow within a body. It combines two effective therapies into one unit, regulating temperature and pressure at the desired site. The invention is composed of a temperature-regulated heat exchange surface, a chamber and seal for enclosing the treatment site at a desired pressure, and an operator-set control unit that manages the heat exchange surface temperature and/or the pressure. These components can be combined into one unit or separated into multiple units. The pressure within the chamber may be managed in multiple ways, including a pump within the control unit and connected to the chamber with vacuum lines, a pump mounted on the chamber itself, or a pump wholly separate from the heat exchange surface, control unit, or chamber. The heat exchange surface can provide a desired temperature in multiple ways, including manifestations similar to an electric wire heating pad, or to a fluid-, gas- or gel-filled pad.

### SUMMARY OF THE METHOD

As described above, many medical conditions are amenable to treatment by combined temperature-pressure therapy at the surface of the body.

By medical conditions in the paragraph above are meant a variety of abnormalities recognized by medical professionals to be related to body surface (surface refers to skin and its associated components such as follicles and nerves) and/or subsurface disease conditions (subsurface includes muscles, joints, fluids, and their associated components such as ligaments and nerves). These disease conditions include overt pathologies for which healing may be promoted such as wounds (contused, incised, open, penetrating, and puncture), skin disorders, joint disorders, inflammation, pain, infection, circulatory insufficiencies of blood or lymph, temperature insufficiencies due to lack of metabolic activity or blood flow within the tissue, and tissue repair and immune system promotion (including increased delivery of therapeutic agents to the tissue from the blood stream). The covered disease conditions also include prophylactic therapy of symptoms, for which the therapy may or may not promote healing, including genetic or overuse disorders such as arthritis, carpal tunnel syndrome, pain, diabetes, sports injuries, Reynaud's Syndrome, and localized tissue therapy to promote patient comfort. The interpretation of prophylactic treatment of symptoms is extended to include prevention of symptom occurrence, such as maintaining tissue at a given temperature appropriate to the medical condition or for comfort of the patient. The term ‘patient’ is meant to include any animal, but most often refers to a human.

By temperature therapy in the first paragraph above is meant the application of a heat exchange surface, or therapy pad, to the surface of the patient's body. The heat exchange surface is set by the operator of the control unit to an appropriate therapeutic temperature that may be above normal physiological temperatures (normal is 36-38° C. for mammals, and this range is referred to as normothermia) to increase fluid flow into the tissue and/or to promote metabolic activity of cells and tissues in the treatment area. The heat exchange surface may be set at normal physiological temperatures to restore and promote normal function and/or to create patient comfort in tissues not at normothermia prior to treatment. By normal function is meant tissue parameters recognized to fall within two standard deviations of the average measurement of that parameter within the population. The heat exchange surface may be set below normal physiological temperatures to slow metabolic activity and fluid flow within tissues, particularly for the treatment of inflammation or pain. The heat exchange surface may also cycle through the range of therapeutic temperatures (above, at, or below normothermia) within a treatment session as is appropriate for the medical condition. The period of the oscillations may be variable, but would usually range from 10 minutes to 60 minutes during a treatment session.

By pressure therapy in the first paragraph above is meant the application of a pressure greater than the ambient pressure experienced by the whole of the patient, for example, one atmosphere at sea level. The sealed pressure chamber may be evacuated by the pressure pump to allow the enclosed tissue to experience lower than ambient pressures which are intended to promote fluid flow and tissue migration into the enclosed tissue. The magnitude of the decrease may be small, less than 10 mmHg, but could range up to levels capable of damaging tissue, approximately 800 mmHg. The pressure pump may increase the density of air in the sealed pressure chamber to expel fluid from the enclosed tissue. The magnitude of the increase could again be small, less than 10 mmHg above ambient, but may also range up to levels capable of damaging tissue, greater than 300 mmHg. The therapy may be a constant positive or negative pressure, but may also cycle back and forth between positive, negative, and ambient to promote both inflow and outflow of fluid and cells from the enclosed tissue. The period of the oscillations may be variable, but would usually range from seconds to minutes.

To practice the temperature-pressure therapy as outlined above, an opinion is formed by the patient, medical practitioner, or other concerned person, that a given condition of the patient's is amenable to such treatment. A heat exchange therapy pad sized and shaped appropriately for the treatment site is then placed in proximity to the body surface, and fastened into place. A pressure chamber sized and shaped to cover both the treatment site and the heat exchange therapy pad is fit over the body site and heat exchanger, and sealed onto the skin surface of the patient. Communicating lines from the heat exchange surface and the pressure chamber are attached to the control unit and pressure pump as needed. Appropriate temperature(s) and pressure(s) are selected at the control unit and the heaters/coolers and pressure pump are turned on. Some therapeutic intervals for treatment will be minutes, but most often treatment will range from hours to days and even weeks. The longer treatment intervals will include healing of chronic wounds and treatment of chronic syndromes like arthritis and diabetes.

The above methods describe the basic treatment system of a heat exchange surface and its associated control unit, and the pressure chamber with its associated pressure pump. The system can have added accessories for additional functions. One such accessory includes the ability to access the treatment site with a tube or other means to administer therapeutic agents to the treatment site. Such therapeutic agents include pharmaceuticals, drying and ventilation gases or solids, or compounds to wash or otherwise cleanse the site. This therapeutic treatment extends to the removal of the administered substances, for instance wetting a wound site and then removing excess fluids. This tube or other means to access the treatment site may also abstract body-derived substances from the treatment site. Such tubes may be connected to the pressure pump as the source for blowing or suction. Another such accessory is a dressing appropriate for the treatment site, such as an absorptive surface for a wound, or a gel between the skin surface and the heat exchange surface to maximize heat transfer. Another such accessory may be a protective surface for the heat exchange surface to facilitate cleanliness of the heat exchange surface. The dressing or other accessory can be made a part of the heat exchange therapy pad for easy administration to the patient.

### BRIEF DESCRIPTION OF THE DRAWINGS

One possible manifestation of the various features of the invention will now be described with reference to the drawings. The drawings and associated descriptions are meant only to illustrate one version of the invention and not to limit the scope of the claims.

FIG. 1 shows a perspective view of a control unit separate from the heat exchange therapy pad and pressure chamber. The current embodiment of a control unit provides power, user interface, control functions for the heat exchange surface and pressure chamber, a pump to provide pressure to the pressure chamber, and a pump to circulate warmed fluids or gases to the heat exchange surface. In this manifestation circulating fluid provides the temperature to the heat exchange surface of the therapy pad, so a cartridge or reservoir space is contained within the control unit to pump said fluid.

FIG. 2 shows a perspective view of a shaped and disposable cartridge and heat exchange therapy pad for a human foot. In this embodiment of the invention a pre-filled fluid line passes between a cartridge that interfaces with the control unit, and a heat exchange therapy pad that is situated over the foot and which contains circulating fluid.

FIG. 3 shows a side view of a pressure chamber unit shaped for a human foot. The pressure chamber surrounds the patient's foot and the heat exchange therapy pad. As shown in the current embodiment, the chamber is like a clamshell that opens on a hinge for insertion of the foot and therapy pad, then closes and seals around the patient's leg. The pressure chamber has lines that communicate with the control unit that in this embodiment contains the vacuum pump for pressurizing the chamber.

### DETAILED DESCRIPTION OF THE INVENTION

One embodiment of the present invention of a temperature/pressure therapy system is described herein. Specific details of this design for the human foot are set forth, including the arrangement and makeup of the components of the heat exchange therapy pad, pressure chamber, and control unit. These details are provided only to illustrate one embodiment of the system, not to limit the scope of the claims for this invention.

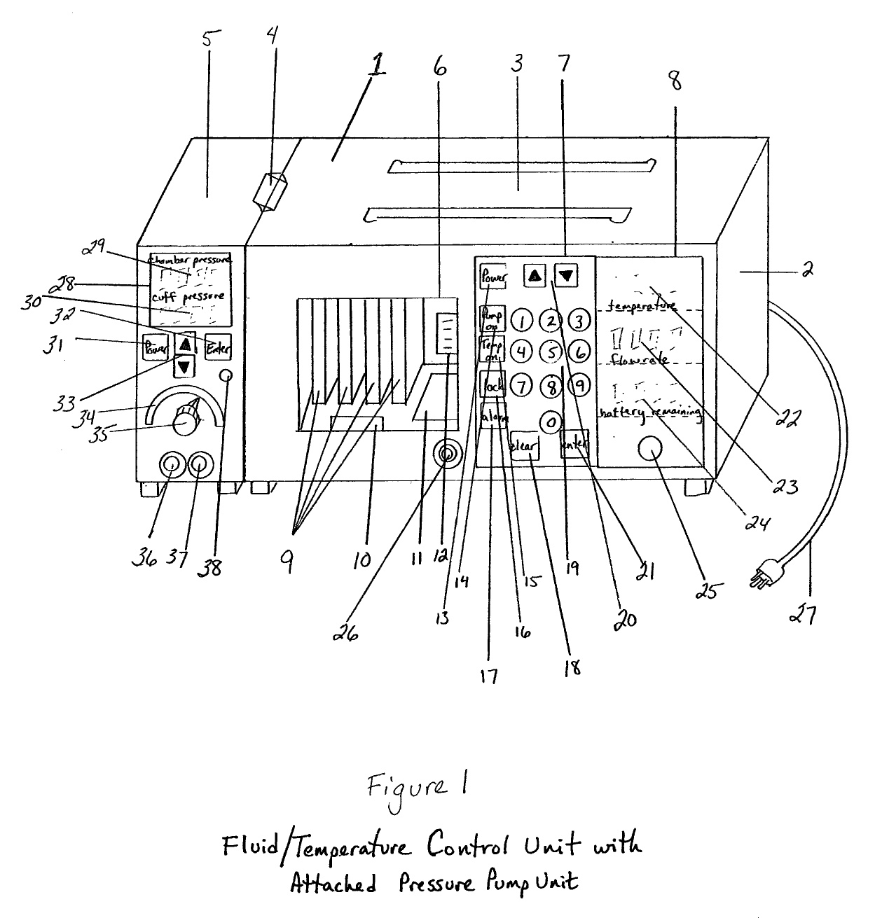

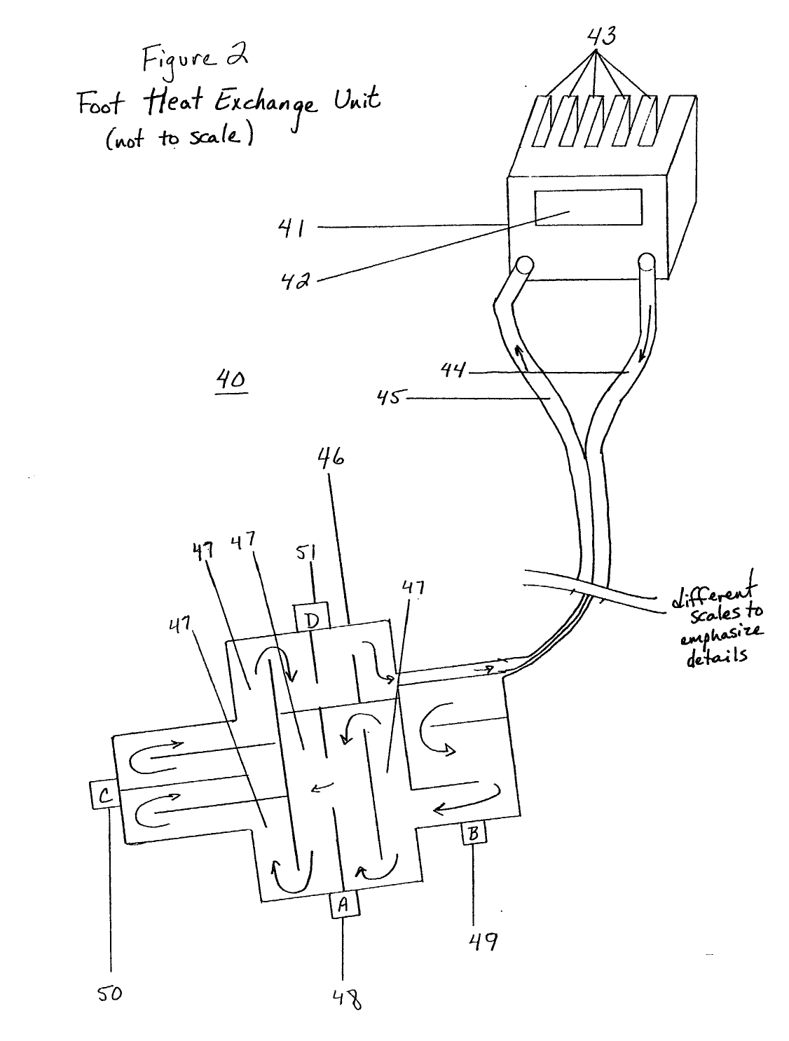

FIG. 1 illustrates a control unit 1, of an embodiment of the invention comprising a case 2, a handle 3, an attachment clip for an accessory unit 4, a separable vacuum pump unit 5, a receptacle 6 for insertion of a cartridge or reservoir, a plurality of temperature and flow rate controls 7, and a plurality of indicator lights 8. This embodiment of a control unit manages the temperature and circulation rate of fluid within a separate cartridge 40 as shown in FIG. 2.

Referring to FIG. 1, a cartridge 40 (not shown) is inserted into the receptacle 6, which contains a plurality of temperature elements 9, a cartridge locking mechanism 10, a fluid pump (not shown) and pump/cartridge interface 11, and a fluid monitoring interface 12. The temperature and flow rate of the fluid moving through the cartridge 40 is operated through control panel 7, on which in the current embodiment shows a power switch 13 for the entire unit, an on/off switch for the fluid pump 14, a locking switch 16 that activates mechanism 10, an alarm 17, and a clear switch 18. Control panel 7 also contains a numeric keypad 19, increase and decrease switches 20, and an Enter key 21. Adjacent to control panel 7 are a plurality of indicator lights 8 that in this design show fluid temperature 22 within the cartridge, fluid flow rate 23 within the cartridge, and battery power 24 available. Indicator lights 22 and 23 can be set to show the temperatures and flow rates set by the operator by pushing button 25. The control unit 1 continuously monitors both set temperature and flow rate, as well as the actual fluid temperature and flow rate within the cartridge. Data port 26 allows external input, monitoring, and downloading of information about the operation of the control unit. A keying mechanism may be built into the cartridge 41 (not shown) and decoded by an element within receptacle 6 to allow automatic setting of the temperature so that the operator does not have to enter that information via control panel 7. Such a keying mechanism could be mechanical, including pins, latches or other protrusions that depress switches within or next to receptacle 6, or the keying mechanism could be electrical, magnetic, optical, or any combination of these and other information transfer mechanisms. Any element of control panel 7 and indicator lights 8 currently shown on the front of control unit 1 may be placed on the top, front, or side panels of the case 2. Any element of control panel 7 and indicator lights 8 may be illuminated, color-coded, shaped, or otherwise distinguished for easy visual monitoring or tactile manipulation in adverse circumstances.

The receptacle 6 provides an easily accessible and robust entry point for a cartridge, reservoir or other container that brings a thermally conductive fluid or gas into proximity with the heating and pumping components of control unit 1. The cartridge 40 (not shown) or fillable reservoir (not shown) comes into reversible intimate contact with the heating elements 9, pump interface 11, and fluid monitoring interface 12, and is locked into place by mechanism 10. Intimate contact between the cartridge and components provide heat exchange between the cartridge and heating elements 9. The temperature elements 9 are fabricated from materials with durability and good heat exchange capacity such as steel, aluminum, copper or other metals, but may include ceramics, plastics, or any other material with high heat transfer capacity. Temperature may be supplied by any technology including resistance, microwave, or infrared heaters, refrigeration coils, or Pelletier devices. The design of the temperature elements 9 maximizes surface area contact with the meshing cartridge heat exchange surface. Such high surface area configurations include multiple projections as illustrated in FIG. 1. The operator controls temperature through either a keying mechanism built into the cartridge 40 and decoded within receptacle 6, through the keypad 19 and control panel 7, through the increase/decrease buttons 20, or via the data port 26.

Also within receptacle 6 is an interface 11 with an underlying fluid pump (not shown). This interface 11 provides intimate and reversible contact with a diaphragm, roller, or other means of pumping fluids or gases through the corresponding interface on the heat exchange unit 40 (not shown, FIG. 2). The pump (not shown) connects with interface 11 and can be of any pump configuration including roller, piston, cam rocker arm or other type of pump. The adjacent and snug fitting of the pump interface 11 with the pumping surface (not shown) of the cartridge 41 (not shown) allows the pump to circulate the heat exchange medium through the heat exchange unit 40 (not shown). The operator specifies flow rate through the keypad 19 and control panel 7, through the increase/decrease buttons 20, or via the data port 26.

Referring still to FIG. 1, locking mechanism 10 provides the receptacle 6 and the cartridge 40 (not shown) with a positive but reversible engagement of those components that provide stable and proximate contact between the interlocking surfaces of the receptacle 6 and the cartridge (not shown). Such locking mechanisms include but are not limited to clips, clamps, or magnetic interfaces. Locking mechanism 10 may also serve to alter the configuration of the cartridge 40 so as to increase the contact between the cartridge 40 and components of the receptacle 6, specifically the heating elements 9, pumping interface 11, and fluid monitoring interface 12.

Not shown in FIG. 1 is the power supply of control unit 1. Electrical power is supplied to control unit 1 by either a power supply (not shown) or a battery (not shown) attached or incorporated into case 2. A power cord 27 is mechanically and electrically connected to the power supply (not shown). A separable battery (not shown) can attach to the case 2 to provide power when other power is unavailable or unadvised. This battery can be single use or rechargeable, and may be connected to the power supply directly for recharging or through the case 2 or internal chassis connections (not shown). The battery is easily accessible for replacement even when units are stacked. Many different battery technologies are appropriate for this application, including but not limited to lead acid, nickel metal hydride, lithium ion, and others. The preferred embodiment of the power supply is configured to allow both 110 VAC US and 240 volt AC international power configurations, as well as the 12 volt DC power available in motor vehicles.

The current design of this invention shown in FIG. 1 has a case 2 that surrounds, protects, and is mechanically affixed to an internal chassis (not shown). The case 2 protects the components of the control unit 1 from the environment. The chassis and case provide the physical structure to which all other components of the control unit are attached, and electronically isolate and cushion the other components. This invention is intended for a number of different medical environments, including emergency and field use, in-hospital use, and home care, so the design and placement of components may vary according to the intended use. This invention is designed to be robust, and may include such features as rubberized coatings to mitigate impacts, and high strength connections between components. The case 2, internal chassis (not shown), handle 3, receptacle 6, control panel 7, and indicator lights 8 may be designed for durability, easy manipulation, and good visual observation at a distance by personnel. The alphanumeric display of temperature 22, flow rate 23, and battery power 24 are also intended to be visible at a distance for monitoring of the unit. These displays may be of any type, including but not limited to LED, LCD, TFT, plasma, CRT or the like. The case 2 may also have an exterior clamp, bracket or other means (not shown) for attachment of the unit to a support such as a stand or bracket, to stabilize the case 2 on a surface, or to link a multiplicity of units together. The handle 3 on top of the case 2 may be extendable, recessed, or adjustable. The receptacle 6 may be affixed to the front, top, or side panels of the case 2 and serves as the opening into which a fluid-containing cartridge or reservoir may be placed.

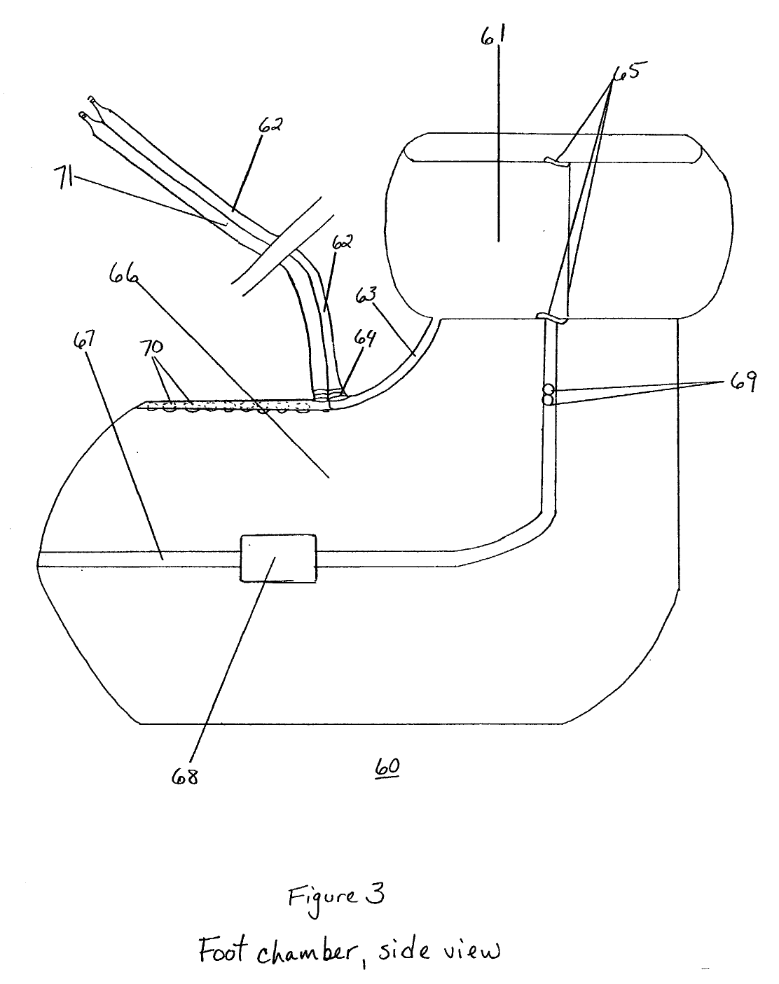

An accessory unit to control unit 1 is shown in FIG. 1. In this embodiment of the invention the vacuum pump unit 5 is attached to the control unit 1 with a mechanical clip 4. The attachment of an accessory unit may be on the top, bottom, side, or back of the case 2, and may be though any mechanical, electrical, or other means. The vacuum pump unit 5 shown here may also be directly incorporated into the control unit 1 so it is not separable. The vacuum pump unit 5 may stand alone or be incorporated into any other component of the therapy system, including the therapy pressure chamber 60 (not shown, FIG. 3). Other accessory units not shown here may provide additional functions not herein specified. The vacuum pump unit 5 communicates with the therapy pressure chamber (not shown) sealed to the site requiring therapy on the patient, and to the control unit 1 for a power supply. The vacuum pump unit 5 manipulates the pressure within the therapy pressure chamber 60 (not shown), including creating pressure above and below the atmospheric pressure to which the entirety of the patient is subjected. The vacuum pump unit 5 also controls the pressure within the cuff or other mechanism by which pressure chamber 60 (not shown) seals to the patient's body part when such a cuff or mechanism requires pressure. Vacuum pump unit 5 is capable of establishing and holding pressure up to the point of physiological injury within case 66 (not shown).

In FIG. 1 the vacuum pump unit 5 in the current embodiment shows an indicator panel 28 with one chamber pressure display 29 for pressure within the pressure chamber 60 (not shown) and one cuff pressure display 30 for pressure within the cuff 61 (not shown) that seals the chamber to the patient's leg (not shown). The vacuum pump unit 5 has a unit power switch 31, an Enter switch 32, and a set of increase/decrease control buttons 33. Also shown in this embodiment are a selector knob 35 and dial 34 for setting the pressure in the chamber or cuff, one port 36 for case communicating line 71 not shown) with pressure chamber 60 (not shown), one port 37 for seal communicating line 62 with cuff 61 (not shown), and a data port 38 for input, monitoring or downloading data related to the vacuum pump unit 5. Vacuum pump unit 5 may contain one or a plurality of pumps to control pressures in various places within the pressure chamber unit 60; the vacuum pump may also serve as a pressurization pump. Vacuum pump unit 5 may draw or create pressure up to 800 mm Hg, but preferentially draws or creates pressures between 0 and 60 mm Hg.

The control unit 1 in FIG. 1 is part of a modular system designed to allow a medical caregiver to deliver temperature-controlled fluids or gases to a heat exchange therapy pad 46 (not shown) proximal to a patient. Controlled temperature combined with pressure supplied by the vacuum pump unit 5, may be desirable for the health and/or comfort of a patient. The embodiment described herein is not the only form of a control unit capable of delivering heat to a patient at, above, or below normothermia, and pressure at, above, or below atmospheric pressure. Such delivery of heat or pressure may be constant or cyclic in any combination of conditions at, above, or below normal. Control unit 1 is self-contained and portable, weighing approximately less than 20 pounds and capable of operating when not connected to an external power source.

FIG. 2 illustrates a disposable heat exchange unit 40 of this embodiment of the invention. The heat exchange unit 40 may also be multi-use or non-disposable. The heat exchange unit 40 consists of a cartridge 41, a heat exchange therapy pad 46, and communicating lines 44 and 45 between the cartridge 41 and heat exchange therapy pad 46. The cartridge 41 of the heat exchange unit 40 comprises the frame for delivering temperature management and pumping to fluid or gases within the heat exchange unit 40. Such fluids or gases circulate between the cartridge 41 and heat exchange therapy pad 46 to create a temperature-controlled surface at the interface with a patient.

As shown in FIG. 2, the cartridge 41 is configured to correspond to the shape of receptacle 6 in control unit 1. It has a label 42 describing the characteristics of cartridge 41, particularly any information that is automatically conveyed to control unit 1 by the insertion of the cartridge 41. Within the frame or surface of cartridge 41 are heat transfer surfaces 43 shaped for maximum surface area contact with heating elements 9 in the receptacle 6. These heat transfer surfaces 43 are designed to transfer maximal heat to the fluid or gas medium traveling through the heat exchange unit 40, and may be altered when cartridge 41 is inserted into receptacle 6 in order to maximize surface contact. In this embodiment the heat transfer surfaces 43 are reverse or mirror image projections corresponding to the projections of the heating elements 9, and the projections intercalate together allowing for reversible interlocking and intimate contact between said surfaces. Contained within cartridge 41 but not visible in this projected view is a specialized surface for interfacing with the pump 11. This pumping element (not shown) may be a diaphragm, rotary component, or collapsible volumetric component such as tubing. Also contained within cartridge 41 but not shown are the interfaces for the control unit 1 fluid monitoring interface 12, and the locking mechanism 10. These interfaces are on the back and underneath surfaces of the projected view of cartridge 41, and may be integral to or affixed to the surface of cartridge 41. Contained within cartridge 41 may also be information that will automatically set temperature or flow rate within control unit 1. This information may be mechanical, such as a shape, electrical, or any other means.

In this embodiment cartridge 41 has an outlet with tubing 44 that communicates with the heat exchange therapy pad 46. Fluid or gases leave cartridge 41 and travel to the heat exchange therapy pad 46 through tubing 44. There may be a heat sensor in tubing 44 to detect the temperature of the heat transfer medium along the length of the tubing or at the distal end of the tubing to allow the control unit 1 to deliver the heat transfer medium to the heat exchange therapy pad 46 at a specific temperature or range of temperatures. The distal end of tubing 44 is affixed to the heat exchange therapy pad 46. Heat exchange therapy pad 46 has a plurality of passages 47 through which the heat exchange medium flows before exiting the heat exchange therapy pad 46 and returning to cartridge 41 through connecting tubing 45. The tubing 44 and 45 may consist of any materials including but not limited to PVC, CPVC, polyethylene, polypropylene, polyurethane and the like; tubing 44 and 45 may be insulated to prevent heat loss along its length, including nested tubing, external tube wraps, and other means. In this embodiment the tubing is flexible, transparent, and medically inert. Other embodiments could have tubing or other transfer passages that are stiff, tinted or non-transparent, or containing medically relevant materials. The tubing or other means of transporting the heat exchange medium may be unnecessary in an embodiment in which the cartridge 41 and heat exchange therapy pad 46 are combined. The tubing may contain uni-directional valves to enhance the fluid flow.

Referring to FIG. 2, the heat exchange therapy pad 46 is designed to fit onto the surface of a patient (not shown) to transfer warmth or cooling to the surface of the patient for medical or comfort reasons. The heat exchange medium, in this embodiment a fluid or gas, circulates throughout the heat exchange unit 40, and throughout the passages of the heat exchange therapy pad 46. The heat exchange unit 40 may be prefilled with heat exchange medium, or filled as needed by the patient or care giver. The heat exchange therapy pad 46 has two surfaces, a top layer which contacts the patient and the bottom layer. The top layer is designed for maximal temperature transfer between the circulating heat transfer medium and the patient, and can be made of any heat conductive material including but not limited to metals, plastics, ceramics, or other materials. The top layer which contacts the patient may also provide a barrier to shield a wound, or provide medically relevant compounds for treating the body part including but not limited to pharmaceuticals, drying agents, wetting agents, antiseptic agents, or sterilizing agents. The top layer may have a covering that can be disposable for easy sanitary maintenance of the heat exchange surface. The heat exchange therapy pad 46 may be sterilized to prevent contamination of the body part of the patient. The bottom of the heat exchange therapy pad 46 may be insulated, or otherwise covered for protection against heat loss, puncture, to provide support and shaping, to connect with the pressure chamber 60 (not shown), or other purposes. The heat exchange therapy pad 46 may be shaped or put onto the patient in such as way as to allow access to the body surface of the patient for reasons of medical treatment, including but not limited to administration or removal of pharmaceuticals, removal of bodily fluids, or examination of the site.

In this embodiment the heat transfer therapy pad 46 is configured for the human foot, and must be flexible for folding over the foot. Other embodiments may be stiff or shaped for the body part of concern. In this embodiment the foot could be placed upon the surface of heat exchange therapy pad 46 in such a way that tab 48 would cross the instep and adhere to tab 51, tab 49 would cross and surround the heel and ankle of the patient, and tab 50 would fold back and fasten over the toes. The heat transfer therapy pad 46 may also be shaped in such a way as to fit directly onto the body part, in this embodiment it could be shaped like a sock. In such a manner or others the heat exchange therapy pad 46 would surround and cover the body part of interest on the patient. The heat exchange medium circulated by the control unit through the heat exchange unit 40 would transfer warmth or cooling to the patient, thereby regulating the temperature of the body part of the patient.

FIG. 3 illustrates a pressure chamber 60 that encloses a body part of the patient and the heat transfer therapy pad 46. In the current embodiment pressure chamber unit 60 is made up of a cuff 61 that surrounds the area of treatment and seals to the patient, a shaped pressure case 66 appropriate for the body part of the patient, and communicating lines 62 and 71 between the pressure chamber 60 and the vacuum unit 5 (not shown).

Referring to FIG. 3, the cuff 61 of pressure chamber unit 60 surrounds the body part of the patient proximal to and including the site of treatment. Cuff 61 may be sealed by a number of mechanisms including but not limited to an iris mechanism, a pneumatic mechanism, straps, elastic material, rubberized material, adhesive material and the like. In the current embodiment pressure chamber unit 60 is shaped for a human foot, and cuff 61 surrounds the leg at or above the ankle (patient not shown). The cuff 61 is inflated through seal communicating line 62 that enters the vacuum pump unit 5 at port 37 (not shown). Seal communicating line 62 connects to pressure chamber 60 at attachment point 64, which communicates with the cuff through passageway 63. Sensors and valves may be located at any point within seal communicating line 62, passageway 63, attachment point 64, or cuff 61. The communicating lines 62 and 71 may be of any material capable of acting as a pressurized line including but not limited to vacuum hose and rigid tubing. Communicating lines 62 and 71 may be eliminated in other embodiments in which the vacuum pump unit 5 is incorporated into pressure chamber 60.

In the current embodiment pressure supplied by vacuum pump unit 5 (not shown) inflates cuff 61 pneumatically, and seals pressure case 66 to the patient's leg (not shown). The seal to the patient may be leaky and require constant adjustment by the pump, or the seal may adhere tightly to the patient's skin and prevent loss of pressure within pressure chamber 60. The seal is intended to allow control unit 1 to establish a desired pressure or sequence of pressures at the surface of the body part to be treated. The cuff 61 may not be tightly adherent in all patients due to irregular surfaces on the body part such as hair or protuberances, so case 66 must be constantly monitored and adjusted to maintain the desired pressure. Pressure within cuff 61 should not impede fluids such as blood or lymph from flowing into or out of the body part unless medically necessary. To extend or interrupt the circumference of cuff 61 and allow insertion of a foot, cuff 61 may have a pleat, elastic strip, laces, separable fastener or other means of adjustment. In the current embodiment, the pressure chamber unit 60 will open like a clamshell, and a separable fastener 65 overlaps the edges of the cuff to allow a seal to form. Materials for separable fastener 65 may include but are not limited to Velcro, snaps, buckles, zipper, clips, clamps, straps, hook-and-eye or other means.

Referring to FIG. 3, case 66 is shown as a rigid boot in the current embodiment that fits over a human foot. Case 66 has a hinge on the side not shown that allows it to open like a clamshell along seam 67 and allows the patient's foot (not shown) with the heat exchange therapy pad (not shown) to be placed within case 66. Case 66 is closed over the foot and the edges of seam 67 return to intimate contact. The edges of seam 67 may be made of such materials as are capable of forming an air-tight barrier when in intimate proximity with another surface, including but not limited to gels, adhesives, rubberized materials, and the like. Clip 68 holds the edges of seam 67 together in such a way as to ensure that the edges come into intimate contact. Also within seam 67 are two spaces 69 suitable to allow communicating tubing 44 and 45 of the heat exchange therapy pad 46 to exit case 66 and allow circulation of heat transfer media between the heat exchange therapy pad 46 and cartridge 41 when operating within receptacle 6 of control unit 1. Alternative embodiments may have other spaces to allow access of tubing or other devices for therapeutic means. Case 66 may have other entry sites for tubing or other equipment in order to allow access to the patient for therapeutic purposes. Case 66 may include vents 70 for release of pressure as needed. When seam 67 is sealed and cuff 61 is sealed, the distal end of case communicating line 71 is inserted into port 36 in vacuum pump unit 5. Vacuum pump unit 5 then establishes and maintains pressure within case 66 according to operator's instructions.

Case 66 is a rigid or semi-rigid structure to contain pressure within the pressure chamber unit 60. Case 66 may be made of structurally rigid materials that form a complete shell shaped appropriately for the body part as shown in FIG. 3, and might be of such materials as plastic, resin, or other lightweight and non-collapsible materials. The case 66 could also be made of semi-rigid materials such as neoprene as long as the structural rigidity of the material allows the vacuum pump unit 5 to establish and maintain pressure within case 66. Other designs include but are not limited to scaffolding or ribs of stiff materials over which flexible materials are stretched and which can be assembled or unfolded into case 66, and inflatable shapes that can perform the functions of case 66 when inflated.

Referring to FIGS. 1, 2 and 3, components of the system that contact and cover the patient's body part may be transparent to allow visualization of the body part. In some embodiments, the heat exchange therapy pad 46, the pressure chamber 60, the control unit 1, and the vacuum pump unit 5 may be incorporated together into the same unit, or in various combinations such as incorporating the heat exchange therapy pad 46 into the pressure chamber 60.

The present invention may be embodied in other specific forms but retain the essential spirit and design characteristics. The above description is illustrative of only some possible manifestations of the technology, and are not intended to limit the scope of the invention. The novel methods and system described herein may have numerous other forms, and omissions, substitutions, and changes in the form of the methods and system described herein may be made within the spirit of this invention. The accompanying claims and their equivalents are intended to cover such forms or modifications as would fall within the scope and spirit of the invention. The scope of the invention is therefore indicated by the claims as well as the description. All manifestations that are within the meaning and range of equivalency of the claims are to be embraced within their scope.

We claim:

1. A temperature and pressure management system intended for the treatment of various medical disorders comprising a control unit, a pressure chamber, a means to regulate pressure to the pressure chamber, and a means to regulate the temperature of the treated body portion.

2. A method of body temperature and pressure management comprising the steps of:
finding that a patient has appropriate medical condition(s) or symptom(s) for combined temperature and pressure treatment,
selecting a heat exchange unit appropriately shaped for the body part,
placing the heat exchange surface of the heat exchange unit in the proximity of the body part,
selecting a pressure chamber appropriately shaped for the body part,
placing the body part and heat exchange unit within the pressure chamber,
sealing the pressure chamber, but allowing communicating tubing, wires, or lines to exit the pressure chamber,
connecting the heat exchange unit to the control unit,
selecting the desired temperature or sequence of temperatures,
heating or cooling the heat exchange surface,
connecting the pressure chamber to the pressure pump (if needed),
selecting the desired pressure or sequence of pressures,
generating the desired pressure,
maintaining concurrent temperature and pressure treatment at the surface of the body part for a period of time.

3. The system of claim 1 for the application of treating wounds.

4. The system of claim 1 for the management of bodily fluid flow, including blood and lymph.

5. The system of claim 1 for tissue temperature management by providing temperatures to a body part below, at, and above normal physiological temperature (36-38° C.).

6. The system of claim 1 for tissue pressure management to a body part by providing positive or negative pressures, oscillating between pressures, or providing intermittent pressures.

7. The system of claim 1 wherein the control unit contains one or more of the following elements:
temperature elements for heating or cooling substances that communicate with the heat exchange surface,
means to monitor, detect and display the temperature of substances that communicate with the heat exchange surface,
a pump to circulate substances that communicate with the heat exchange surface,
means to monitor, detect and display the flow rate of substances that communicate with the heat exchange surface,
a port or receptacle to accept the communicating lines from the heat exchange unit,
interfaces and support structures to allow management of substances that communicate with the heat exchange unit,
a pressure pump to provide pressure to the pressure chamber,
internal power source,
operator input capacity for setting and adjusting unit functions,
controls and displays for the temperature elements and pressure pump,
means to communicate with an operator separate from the control panel, such as a data port,
means to store data and download data from the operation of the control unit.

8. The system of claim 1 wherein the pressure chamber contains one or more of the following elements:
means to adhere to the surface of the body surrounding the body part to provide pressure to said body part,
means to provide sufficient structural rigidity to allow pressure to be maintained within the chamber,
means to monitor and detect pressure within the chamber,
means to quickly return the chamber to ambient pressure,
communicating lines with a means to generate pressure,
means to control the generation of pressure,
means to deliver or remove therapeutic agents at the proximal site,
means to remove bodily substances from the proximal site.

9. The system of claim 1 in which the heat exchange unit may contain:
means to monitor and detect the temperature of substances that communicate with the heat exchange surface,
a conductive heat exchange surface at the interface with the body part of a patient for thermal transfer to the surface tissue of the patient,
means to monitor and detect the temperature of the heat exchange surface,
means to monitor and detect the temperature of the adjacent patient skin surface or subsurface tissues,
temperature elements to heat or cool the heat exchange surface or substances that communicate with the heat exchange surface,
insulation to minimize heat transfer away from the site proximal to the body part,
means to deliver or remove therapeutic agents at the proximal site,
means to remove bodily substances from the proximal site.

10. The system of claim 1 wherein a circulating fluid heat exchanger is used to regulate surface temperature of the body part.

11. The system of claim 1 wherein the heat exchange surface is adapted to maintain contact with at least a portion of a body part.

12. The system of claim 1 wherein the heat exchange surface may be encased in a protective sheath or a dressing appropriate for treatment of the medical disorder.

13. The system of claim 1 which derives its temperature from solid, liquid, or gaseous substances, including electrical, chemical or ionic power sources.

14. The system of claim 1 in which components are substantially transparent to permit visual inspection.

15. The system of claim 1 including a pressure chamber that is shaped to enclose a specific body part.

16. The system of claim 1 wherein the temperature of the heat exchange surface is determined automatically from characteristics of, or signals from, the heat exchange unit rather than operator controls.

17. The system of claim 1 wherein there is monitoring and feedback between the patient and the control unit so as to regulate tissue temperature of the patient.

18. The system of claim 1 wherein the power source is from a battery or a socket.

19. The control unit of claim 1 wherein the control unit characteristics and features are incorporated into another medical unit with functions in addition to temperature and pressure management.

20. The system of claim 1 wherein the components may be variously attached to or separated from each other.
